(19) United States
(12) Patent Application Publication
(10) Pub. No.: US 2011/0175576 A1
(43) Pub. Date: Jul. 21, 2011

(54) METHOD AND APPARATUS FOR CHARGING SECONDARY BATTERIES

(75) Inventors: Shinichi Uesaka, Kanagawa (JP); Hiroshi Takabayashi, Kanagawa (JP)

(73) Assignee: SONY CORPORATION, Tokyo (JP)

(21) Appl. No.: 13/004,468

(22) Filed: Jan. 11, 2011

(30) Foreign Application Priority Data
Jan. 19, 2010 (JP) P2010-009289

(51) Int. Cl. H02J 7/04

(52) U.S. Cl. 320/155

(57) ABSTRACT

A secondary-battery electrically charging method includes: measuring the present time point; setting an electrical-charging end time point at which an operation to electrically charge a secondary battery is to be terminated; computing an electrical-charging resumption time point on the basis of the electrical-charging end time point and the length of time it takes to complete the operation to electrically charge the secondary battery on the assumption that the operation is started from a state in which the amount of electric charge stored in the secondary battery has reached an electric-charge amount determined in advance; and carrying out the operation to electrically charge the secondary battery in a first electrical-charging mode in which the operation is stopped after the secondary battery is electrically charged to the electric-charge amount determined in advance and resumed when the present time point reaches the electrical-charging resumption time point.

### CROSS REFERENCES TO RELATED APPLICATIONS

The present application claims priority to Japanese Patent Application JP 2010-009289 filed on Jan. 19, 2010, the entire contents of which is hereby incorporated by reference.

### BACKGROUND

The present disclosure relates to a method and an apparatus which are used for electrically charging a secondary battery. More specifically, the present disclosure relates to a secondary-battery electrically charging method and a secondary-battery electrically charging apparatus which are used for extending the life of a secondary battery by preventing the battery from being left uncontrolled in a state of being electrically charged to the full electric-charge storage capacity of the battery in an operation to electrically charge the battery in order to prevent the battery from deteriorating.

In recent years, the need for sustainable development has been recognized in the world. The development needs to be sustained by finding solutions to both environmental problems and economic growths. Finding solutions to both environmental problems and economic growths is a concept of leaving prosper lives to next generations. However, this concept raises problems including an energy problem which is particularly of importance. In order to solve the energy problem, it is necessary to avoid the warming of the earth and, at the same time, to accomplish further developments in response to rapidly growing demands raised by developing countries as demands for energies. In order to avoid the warming of the earth and accomplish further developments in response to the rapidly growing demands for energies, it is necessary to replace energies derived from fossil fuels supporting the 20th century with energies which can be regenerated. Typical examples of the energies which can be regenerated are the solar energy and an energy generated by a wind power.

In such a world, a gradual transition is being made from the existing way of storing chemical energies in storages in the form of fuels stored in tanks or the like to a new way of storing electrical energies in storage batteries represented by typically lithium-ion secondary batteries prior to the use of the electrical energies. In general, the density of electrical energy stored in a non-aqueous electrolyte secondary battery such as a lithium-ion secondary battery is high in comparison with the density of electrical energy stored in battery of another type such as a nickel-cadmium battery or a nickel-hydrogen battery. For this reason, the non-aqueous electrolyte secondary battery such as a lithium-ion secondary battery is widely used in mobile electronic apparatus and the like. Typical mobile electronic apparatus include a note personal computer, a hand phone, a digital camera and a PDA (Personal Digital Assistant).

In an internal chemical battery such as a lithium-ion secondary battery, a chemical reaction occurs and a side reaction of the chemical reaction causes a cycle deterioration and an aged deterioration. If the life of a lithium-ion secondary battery is short, the value of the lithium-ion secondary battery cannot be prevented from becoming economically and environmentally small. Thus, prolonging the life of the lithium-ion secondary battery is a big problem raised in researches and developments. Accordingly, in order to prolong the life of the lithium-ion secondary battery, researches and developments are carried out in an attempt to discover new materials (and/or new cells) for making the lithium-ion secondary battery.

There have been proposals for prolonging the life of the lithium-ion secondary battery by controlling a method for electrically charging the lithium-ion secondary battery. For example, there has been proposed a technology in accordance with which the number of operations to electrically charge a lithium-ion secondary battery at high voltage is counted and, after the number of such operations has exceeded a threshold value determined in advance, an electrical-charging voltage is lowered in order to prolong the life of the lithium-ion secondary battery. In addition, in accordance with another proposed technology, the degree of the deterioration of a lithium-ion secondary battery is inferred and, in accordance with the inferred degree of the deterioration, an electrical-charging current or an electrical-charging voltage is reduced. On top of that, in accordance with a further proposed technology, the voltage of a lithium-ion secondary battery is measured and, if the measured voltage is higher than a threshold voltage determined in advance, an operation to electrically charge the secondary battery is not carried out. In accordance with the proposed technologies, the electrical-charging voltage is lowered (or the electrical-charging current is reduced) or an operation to electrically charge the secondary battery is not carried out for a high voltage appearing on the lithium-ion secondary battery in an attempt to prevent the lithium-ion secondary battery from deteriorating. This is because, if a lithium-ion secondary battery having a high voltage is electrically charged or left uncontrolled, an inadvertent chemical reaction occurs in the lithium-ion secondary battery, causing the lithium-ion secondary battery to deteriorate fast. Thus, in order to prolong the life of a lithium-ion secondary battery, it is important to prevent the lithium-ion secondary battery from being left uncontrolled in a state of being electrically charged to the full electric-charge storage capacity of the secondary battery in an operation to electrically charge the secondary battery.

If the user-side usability of the lithium-ion secondary battery is taken into consideration, on the other hand, it is necessary to complete an operation to electrically charge the lithium-ion secondary battery to a state of being electrically charged to achieve the full electric-charge storage capacity of the lithium-ion secondary battery before the user makes use of the lithium-ion secondary battery. Thus, in order for the existing electrical-charging apparatus to complete the operation to electrically charge the lithium-ion secondary battery as quickly as possible, the electrical-charging apparatus starts the operation to electrically charge the lithium-ion secondary battery as soon as the lithium-ion secondary battery is connected to the electrical-charging apparatus. Accordingly, in accordance with a method for electrically charging a lithium-ion secondary battery, it is necessary to satisfy two conditions which are contradictory to each other as follows. The first condition demands that an attempt be made as far as possible not to electrically charge the lithium-ion secondary battery to a state of being electrically charged to the full electric-charge storage capacity of the lithium-ion secondary battery in order to prolong the life of the lithium-ion secondary battery. On the other hand, the second condition demands that the lithium-ion secondary battery be put in a state of being electrically charged to achieve the full electric-charge storage capacity of the lithium-ion secondary battery in an operation to electrically charge the secondary battery at any time desired by the user in order to provide the user with convenience.

In order to satisfy the two conditions described above, there has been proposed an electrical-charging apparatus for electrically charging a secondary battery. The electrical-charging apparatus is provided with a battery residual-electric-charge amount detection section configured to find the amount of residual electric charge left in the secondary battery and a time-point measurement section configured to measure the length of time it takes to electrically charge the secondary battery on the basis of the amount of battery residual electric charge left in the secondary battery. In addition, the electrical-charging apparatus further finds an electrical charging start time point on the basis of a given electrical-charging end time point and the length of the time it takes to electrically charge the secondary battery. As the electrical charging start time point is reached, the electrical-charging apparatus starts an operation to electrically charge the secondary battery. For more information on this the electrical-charging apparatus, the reader is advised to refer to Japanese Patent Laid-open No. 2000-253596 (hereinafter referred to as Patent Document 1).

### SUMMARY

In the electrical-charging apparatus for electrically charging a secondary battery as described in Patent Document 1, however, it is not until the electrical charging start time point that an operation to electrically charge the secondary battery is started even if the secondary battery is connected to the electrical-charging apparatus. Let us assume the following case as an example. There is almost no residual electric charge left in the second battery. At 23:00 PM, the user connects an electronic apparatus employing the secondary battery to the electrical-charging apparatus. The user sets the electrical-charging end time point at 7:00 AM on the following day and, all of a sudden, wants to make use of the electronic apparatus right away after the user connects the electronic apparatus from the electrical-charging apparatus. It is to be noted that the length of time it takes to electrically charge the secondary battery from a state of almost no residual electric charge left in the second battery to a state of being electrically charged to the full electric-charge storage capacity of the secondary battery is three hours. Thus, on the basis of the given electrical-charging end time point of 7:00 AM and the three-hour length of the time it takes to electrically charge the secondary battery, the electrical-charging apparatus finds that electrical charging start time point is 4:00 AM on the following day. Accordingly, it is not until the electrical charging start time point of 4:00 AM that an operation to electrically charge the secondary battery is started. As a result, the electrical-charging apparatus raises a problem that the user cannot make use of the electronic apparatus immediately in case, all of a sudden, the user must make use of the electronic apparatus after the electronic apparatus is connected to the electrical-charging apparatus.

In addition, the electrical-charging apparatus described in Patent Document 1 measures the length of time it takes to electrically charge the secondary battery. Then, the electrical-charging apparatus further finds an electrical charging start time point on the basis of an electrical-charging end time point specified by the user and the length of the time it takes to electrically charge the secondary battery by subtracting the length of the time from the electrical-charging end time point. If the time it takes to electrically charge the secondary battery is longer than the period of time between the time point at which the electronic apparatus employing the secondary battery is connected to the electrical-charging apparatus and the electrical-charging end time point, however, the electrical-charging apparatus also has a problem of a time insufficiency and Patent Document 1 does not describe solutions to this time-insufficiency problem.

The present embodiments provide a secondary-battery electrically charging method and a secondary-battery electrically charging apparatus which are capable of preventing the secondary battery from being left uncontrolled in a state of being electrically charged to the full electric-charge storage capacity of the battery in an operation to electrically charge the battery in order to prevent the battery from deteriorating and are configured to start an operation to electrically charge the secondary battery as soon as the secondary battery is connected to the secondary-battery electrically charging apparatus so that the user can make use of the secondary battery right after the start of the operation to electrically charge the secondary battery.

In order to solve the problems described above, in accordance with a first embodiment, there is provided a secondary-battery electrically charging method having:

a time measurement step of measuring the present time point;

an electrical-charging end time-point setting step of setting an electrical-charging end time point at which an operation to electrically charge a secondary battery is to be terminated;

an electrical-charging resumption-time-point computation step of computing an electrical-charging resumption time point on the basis of the electrical-charging end time point and the length of time it takes to complete the operation to electrically charge the secondary battery at the electrical-charging end time point on the assumption that the operation is started from a state in which the amount of electric charge stored in the secondary battery has reached an electric-charge amount determined in advance; and

an electrical-charging control step of carrying out the operation to electrically charge the secondary battery in a first electrical-charging mode in which the operation is stopped after the secondary battery is electrically charged to the electric-charge amount determined in advance and resumed when the present time point reaches the electrical-charging resumption time point.

In addition, in accordance with a second embodiment, there is provided a secondary-battery electrically charging method having:

a time measurement step of measuring the present time point;

an electrical-charging end time-point setting step of setting an electrical-charging end time point at which an operation to electrically charge a secondary battery is to be terminated;

a battery residual electric-charge amount detection step of detecting the amount of residual electric charge left in the secondary battery at the start of the operation to electrically charge the secondary battery; and

an electrical-charging control step of carrying out the operation to electrically charge the secondary battery by beginning the operation at the start at which the amount of residual electric charge left in the secondary battery is detected and by adjusting an electrical-charging current so as to terminate the operation at the electrical-charging end time point.

In a third embodiment, there is provided a secondary-battery electrically charging apparatus having:

a time measurement section configured to measure the present time point;

an electrical-charging end time-point setting section configured to set an electrical-charging end time point at which an operation to electrically charge a secondary battery is to be terminated;

an electrical-charging resumption-time-point computation section configured to compute an electrical-charging resumption time point on the basis of the electrical-charging end time point and the length of time it takes to complete the operation to electrically charge the secondary battery at the electrical-charging end time point on the assumption that the operation is started from a state in which the amount of electric charge stored in the secondary battery has reached an electric-charge amount determined in advance; and

an electrical-charging control section configured to carry out the operation to electrically charge the secondary battery in a first electrical-charging mode in which the operation is stopped after the secondary battery is electrically charged to the electric-charge amount determined in advance and resumed when the present time point reaches the electrical-charging resumption time point.

In a fourth embodiment, there is provided a secondary-battery electrically charging apparatus having:

a time measurement section configured to measure the present time point;

an electrical-charging end time-point setting section configured to set an electrical-charging end time point at which an operation to electrically charge a secondary battery is to be terminated;

a battery residual-electric-charge amount detection section configured to detect the amount of electric charge left in the secondary battery at the start of the operation; and

an electrical-charging control section configured to carry out the operation to electrically charge the secondary battery by beginning the operation at the start at which the amount of residual electric charge left in the secondary battery is detected and by adjusting an electrical-charging current so as to terminate the operation at the electrical-charging end time point.

The secondary-battery electrically charging method and the secondary-battery electrically charging apparatus which are provided by the present embodiment are capable of controlling an operation to electrically charge a secondary battery so as to complete the operation at an electrical-charging end time point set by the user in advance. It is thus possible to prevent the secondary battery from being left uncontrolled in a state of being electrically charged to the full electric-charge storage capacity of the secondary battery in the operation to electrically charge the secondary battery in order to prolong the life of the secondary battery. In addition, the secondary-battery electrically charging method and the secondary-battery electrically charging apparatus are configured to start the operation to electrically charge the secondary battery as soon as the secondary battery is connected to the secondary-battery electrically charging apparatus so that the user can start use of the secondary battery right after the secondary battery is connected to the secondary-battery electrically charging apparatus.

Additional features and advantages are described herein, and will be apparent from the following Detailed Description and the figures.

### BRIEF DESCRIPTION OF THE FIGURES

FIG. 1 is a perspective-view diagram showing an external appearance of an electronic apparatus employing a secondary battery and an external appearance of a secondary-battery electrically charging apparatus according to a first embodiment;

FIG. 2 is a block diagram showing the configuration of the secondary-battery electrically charging apparatus according to the first embodiment;

FIG. 3 shows a flowchart representing electrical charging processing carried out by the secondary-battery electrically charging apparatus according to the first embodiment;

FIG. 4 shows another flowchart representing a portion of the electrical charging processing carried out by the secondary-battery electrically charging apparatus according to the first embodiment;

FIG. 5 is a diagram showing a graph representing a relation between time and a voltage appearing on a secondary battery undergoing an operation to electrically charge the secondary battery carried out by the secondary-battery electrically charging apparatus according to the first embodiment;

FIG. 6 is a block diagram showing the configuration of a secondary-battery electrically charging apparatus according to a second embodiment;

FIG. 7 shows a flowchart representing electrical charging processing carried out by the secondary-battery electrically charging apparatus according to the second embodiment;

FIG. 8 is a diagram showing a graph representing a relation between time and a voltage appearing on a secondary battery undergoing an operation to electrically charge the secondary battery carried out by the secondary-battery electrically charging apparatus according to the second embodiment;

FIG. 9 is a diagram showing a graph representing a relation between time and a voltage appearing on a secondary battery undergoing an operation to electrically charge the secondary battery carried out by a secondary-battery electrically charging apparatus according to a modified version; and

FIG. 10 is a perspective-view diagram showing an external appearance of an electronic apparatus employing a secondary battery and an external appearance of a secondary-battery electrically charging apparatus adopting a noncontact electrical charging method according to the modified version.

### DETAILED DESCRIPTION

Embodiments are explained below by referring to diagrams. It is to be noted that the embodiments are described in chapters which are arranged as follows:

1: First Embodiment (controlling an operation to electrically charge a secondary battery by temporarily stopping an operation to supply an electrical-charging current)

2: Second Embodiment (controlling an operation to electrically charge a secondary battery by adjusting the magnitude of an electrical-charging current)
3: Modified Versions

### 1: First Embodiment

External Appearance of an Electrically Charging Apparatus

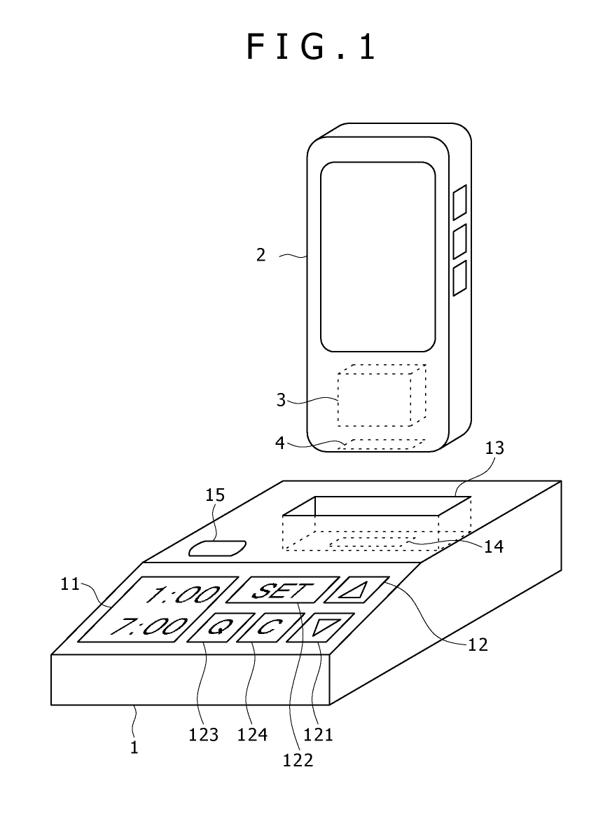

FIG. 1 is a perspective-view diagram showing an external appearance of an electronic apparatus 2 employing a secondary battery 3 and an external appearance of a secondary-battery electrically charging apparatus 1 according to a first embodiment. As shown in the perspective-view diagram which serves as FIG. 1, the secondary-battery electrically charging apparatus 1 is configured to serve as an electrically-charging apparatus for holding the electronic apparatus 2 in a state of erecting the electronic apparatus 2 and for electrically charging the electronic apparatus 2 held in such a state. The electronic apparatus 2 employs a lithium-ion secondary battery 3 to be electrically charged by the secondary-battery electrically charging apparatus 1. In the following description, the lithium-ion secondary battery 3 which is electrically chargeable and dischargeable is referred to simply as a secondary battery 3. Typical examples of the electronic apparatus 2 are a hand phone, a portable game machine and a portable music player. On the bottom of the electronic apparatus 2, there is provided a power receiving connector 4 to be connected to a connection section 14 which is employed in the secondary-battery electrically charging apparatus 1 as described later. It is to be noted that, in this first embodiment, the secondary battery 3 is a lithium-ion secondary battery having a full electric-charge storage voltage of 4.2 V per battery cell. However, the secondary battery 3 is by no means limited to a lithium-ion secondary battery having a full electric-charge storage voltage of 4.2 V per battery cell. That is to say, the secondary battery 3 can be any battery as long as the battery can be electrically recharged and used repeatedly.

The configuration of the secondary-battery electrically charging apparatus 1 is described in detail as follows. A display section 11 is a section configured to function as a display section such as an LCD (Liquid Crystal Display) unit, a PDP (Plasma Display Panel) or an organic EL (Electro Luminescence) display panel. The display section 11 is provided on a front panel portion of the secondary-battery electrically charging apparatus 1. The display section 11 is a section for displaying information such as the present time point Tn and an electrical-charging end time point Tf set by the user. In the first embodiment, the present time point Tn is displayed on the upper side of the display section 11 whereas the electrical-charging end time point Tf is displayed on the lower side of the display section 11. The electrical-charging end time point Tf is a time desired by the user as a time at which an operation to electrically charge the secondary battery 3 is to be completed. The secondary-battery electrically charging apparatus 1 according to the present embodiment carries out an operation to electrically charge the secondary battery 3 to a state of being electrically charged to achieve the full electric-charge storage capacity of the secondary battery 3 at the electrical-charging end time point Tf.

An input section 12 is configured to employ a time-point inputting button 121, a time-point setting button 122, an electrical-charging start button 123 and a cancel button 124 which are provided on the front panel portion of the secondary-battery electrically charging apparatus 1. When the user presses any of the time-point inputting button 121, the time-point setting button 122, the electrical-charging start button 123 and the cancel button 124, an input signal associated with the pressed button is supplied to a control section 27 which will be described later.

The time-point inputting button 121 is configured to include two buttons, i.e., a time-point increment button and a time-point decrement button which function as an input section used by the user to enter an electrical-charging end time point Tf. The time-point inputting button 121 is so configured so that, when the user presses the time-point increment button and/or the time-point decrement button, an electrical-charging end time point Tf displayed on the display section 11 is changed in a manner interlocked with the operations to press the time-point increment button and/or the time-point decrement button. When the user presses the time-point setting button 122 after the user enters the electrical-charging end time point Tf by operating the time-point inputting button 121, the electrical-charging end time point Tf is set in the secondary-battery electrically charging apparatus 1. The electrical-charging start button 123 is an input section for entering a command to start an operation to electrically charge the secondary battery 3. When the user presses the electrical-charging start button 123, the operation to electrically charge the secondary battery 3 is started even if an electrical-charging end time point Tf has been set. That is to say, when the user presses the electrical-charging start button 123, the operation to electrically charge the secondary battery 3 is started without regard to the electrical-charging end time point Tf. The operation started by pressing the electrical-charging start button 123 to electrically charge the secondary battery 3 is an operation carried out to electrically charge the secondary battery 3 in a third electrical-charging mode which will be described later.

The cancel button 124 is a button to be operated by the user in order to enter a command for canceling an electrical-charging end time point Tf set in the secondary-battery electrically charging apparatus 1 or cancelling a started operation to electrically charge the secondary battery 3.

The front panel portion of the secondary-battery electrically charging apparatus 1 is configured to face upward in an inclined direction so that the user can easily look at the display section 11 and operate the input section 12 with ease.

A dent 13 is configured to have an opening on the upper surface of an electrical charging base employed in the secondary-battery electrically charging apparatus 1. When the electronic apparatus 2 is inserted into the dent 13, the dent 13 holds the electronic apparatus 2 in an erected state. The dent 13 is configured to have a depth to a certain degree so that the electrically charging apparatus 1 is capable of holding the electronic apparatus 2 in the erected state. The connection section 14 cited above is a power transferring connector provided on the bottom of the dent 13, being placed at a location at which the power receiving connector 4 provided on the bottom of the electronic apparatus 2 inserted into the dent 13 is positioned. That is to say, when the electronic apparatus 2 inserted into the dent 13, the power receiving connector 4 of the electronic apparatus 2 is brought into contact with the connection section 14 of the secondary-battery electrically charging apparatus 1 so that the electronic apparatus 2 is connected to the secondary-battery electrically charging apparatus 1.

In addition, in about the front of the dent 13, an LED 15 is provided to serve as a communication section for informing the user that an operation to electrically charge the secondary battery 3 is being carried out. The LED 15 is put in a turned-on state showing a color which is varied in order to indicate whether the electrical-charging mode is a first electrical-charging mode, a second electrical-charging mode or another electrical-charging mode such as the third electrical-charging mode cited above. These electrical-charging modes will be described later.

Configuration of an Electrical Charging Circuit

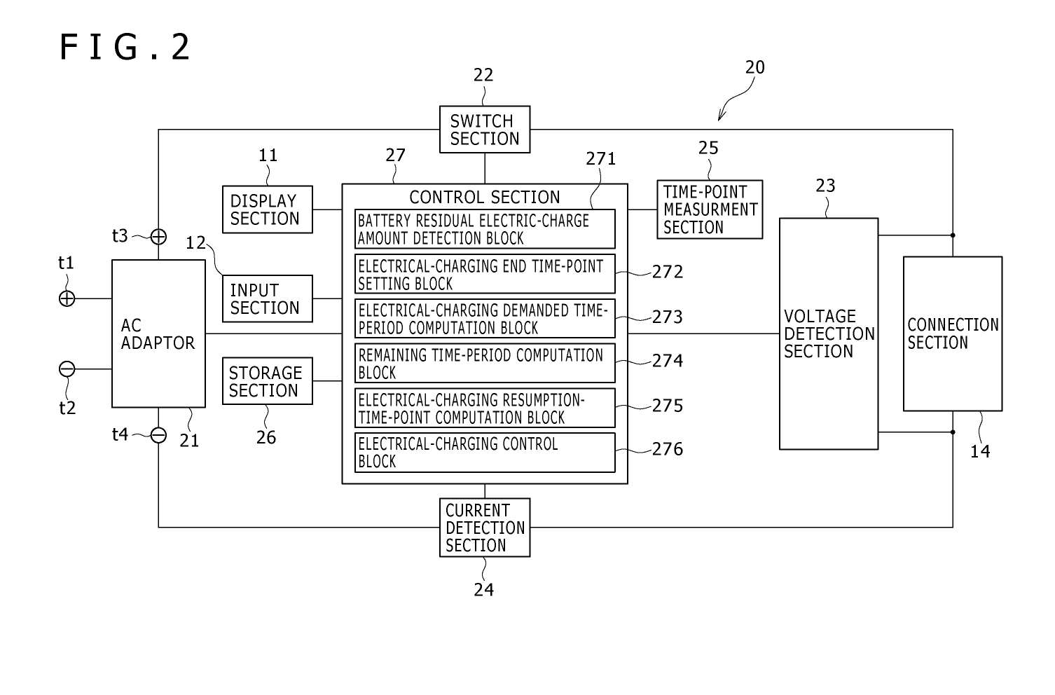

FIG. 2 is a block diagram showing a rough configuration of an electrical charging circuit 20 employed in the secondary-battery electrically charging apparatus 1. As shown in the block diagram which serves as FIG. 2, the electrical charging circuit 20 is configured to include the connection section 14 cited earlier, an AC adaptor 21, a switch section 22, a voltage detection section 23, a current detection section 24, a time-point measurement section 25, a storage section 26 and the control section 27 mentioned before. Furthermore, the control section 27 employs a battery residual electric-charge amount detection block 271, an electrical-charging end time-point setting block 272, an electrical-charging demanded time-period computation block 273, a remaining time-period computation block 274, an electrical-charging resumption-time-point computation block 275 and an electrical-charging control block 276. The control section 27 is also connected to the display section 11 and the input section 12.

Provided with a stable characteristic, the AC adaptor 21 is an AC adaptor functioning as a power source for electrically charging the secondary battery 3. Input terminals t1 and t2 of the AC adaptor 21 are connected to a commercial power source not shown in the block diagram which serves as FIG. 2. The AC adaptor 21 generates a direct-current voltage determined in advance from the commercial power source and outputs the direct-current voltage to output terminals t3 and t4 of the AC adaptor 21.

The switch section 22 is a switch for supplying an electrical-charging current generated from the direct-current voltage to the secondary battery 3 employed in the electronic apparatus 2 or cutting off the supply of the electrical-charging current to the secondary battery 3. The switch section 22 supplies the electrical-charging current to the secondary battery 3 or cuts off the supply of the electrical-charging current to the secondary battery 3 in accordance with a control signal generated by the control section 27 which is connected to the switch section 22. In this way, an operation to electrically charge the secondary battery 3 is carried out, stopped temporarily or terminated in accordance with the switching operations carried out by the switch section 22. The switch section 22 is typically a semiconductor switching device such as an FET (Field Effect Transistor).

The voltage detection section 23 is a section for detecting the voltage appearing on the secondary battery 3 as an analog signal and converting the analog signal obtained as a result of the detection into a digital signal to be supplied to the control section 27. The voltage detection section 23 employs an A/D converter for converting the analog signal into the digital signal. However, the A/D converter itself is not shown in the block diagram which serves as FIG. 2. The current detection section 24 is a section for detecting the aforementioned electrical-charging current supplied by the AC adaptor 21 to the secondary battery 3 by way of the connection section 14. The current detection section 24 includes a resistor through which the electrical-charging current flows. The current detection section 24 detects the electrical-charging current by detecting a voltage appearing on the resistor.

The time-point measurement section 25 is a processing section configured to function as a time measurement section for measuring time. To be more specific, the time-point measurement section 25 is the time measurement section for monitoring the present time point Tn on the real-time axis and generating information on the monitored present time point Tn. The time-point measurement section 25 supplies the generated information on the present time point Tn to the control section 27 which then makes use of the information for a variety of purposes. In particular, the remaining time-period computation block 274 employed in the control section 27 makes use of the information on the present time point Tn to compute a remaining time period Tz which will be described later.

The control section 27 is configured to function as a microcomputer which typically includes a CPU (Central Processing Unit). The control section 27 executes control programs determined in advance, functioning as the battery residual electric-charge amount detection block 271, the electrical-charging end time-point setting block 272, the electrical-charging demanded time-period computation block 273, the remaining time-period computation block 274, the electrical-charging resumption-time-point computation block 275 and the electrical-charging control block 276. The control section 27 displays the present time point Tn and the electrical-charging end time point Tf on the display section 11. The control section 27 also controls all operations carried out by the secondary-battery electrically charging apparatus 1. For example, the control section 27 controls an operation to put the LED 15 in a turned-on or turned-off state.

The battery residual electric-charge amount detection block 271 is a section for detecting the amount of residual electric charge left in the secondary battery 3. Typically, the battery residual electric-charge amount detection block 271 detects the amount of residual electric charge left in the secondary battery 3 by measuring the voltage appearing on the secondary battery 3 or measuring the internal resistance of the secondary battery 3.

The electrical-charging end time-point setting block 272 is a section for setting the electrical-charging end time point Tf on the basis of an electrical-charging end time point entered by the user by operating the input section 12 and storing the electrical-charging end time point Tf in the storage section 26.

The electrical-charging demanded time-period computation block 273 is a section for computing the length of time it takes to carry out an operation to electrically charge the secondary battery 3 to the full electric-charge storage capacity of the secondary battery 3 by supplying an electrical-charging current determined in advance to the secondary battery 3 on the basis of a residual electric charge amount of the secondary battery 3 detected by the battery residual electric-charge amount detection block 271 in an initial state on the assumption that the operation is started from the electrical charging current determined in advance and ended in a state of being electrically charged to the full electric-charge storage capacity of the secondary battery 3. In the following description, the length of the time it takes to carry out an operation to electrically charge the secondary battery 3 as described above is referred to as an electrical-charging demanded time period Tr.

The remaining time-period computation block 274 is a section for subtracting the present time point Tn output by the time-point measurement section 25 from the electrical-charging end time point Tf set by the electrical-charging end time-point setting block 272 in order to compute time left between the present time point Tn and the electrical-charging end time point Tf. In the following description, the time left between the present time point Tn and the electrical-charging end time point Tf is referred to as a remaining time period Tz. That is to say, the remaining time-period computation block 274 computes the remaining time period Tz in accordance with the following equation Tz=Tf−Tn. For example, the electrical-charging end time point Tf is set at 7:00 AM whereas the present time point Tn is 1:00 AM. In this case, the remaining time period Tz is six hours which are the length of time left between the present time point Tn of 1:00 AM and the electrical-charging end time point Tf of 7:00 AM.

First of all, the electrical-charging resumption-time-point computation block 275 computes the length of time it takes to carry out an operation to electrically charge the secondary battery 3 to the full electric-charge storage capacity of the secondary battery 3 on the assumption that the operation is an operation resumed from a temporarily stopped state after being electrically charged to the electric charge amount determined in advance and ended in a state of being electrically charged to the full electric-charge storage capacity of the secondary battery 3. In the following description, the length of the time it takes to carry out an operation to electrically charge the secondary battery 3 on the assumption as described above is referred to as a post-resumption electrical-charging demanded time period Th. The electrical-charging resumption-time-point computation block 275 then subtracts the post-resumption electrical-charging demanded time period Th from the electrical-charging end time point Tf in order to find a time point at which the operation to electrically charge the secondary battery 3 is to be resumed. In the following description, the time point at which the operation to electrically charge the secondary battery 3 is to be resumed is referred to as an electrical-charging resumption time point Ts. That is to say, the electrical-charging resumption-time-point computation block 275 computes the electrical-charging resumption time point Ts in accordance with the following equation Ts=Tf−Th. As will be described later, in a first electrical-charging mode of the first embodiment, an operation to electrically charge the secondary battery 3 is started and temporarily stopped as the secondary battery 3 is electrically charged to the electric charge amount determined in advance before being resumed later at the electrical-charging resumption time point Ts computed by the electrical-charging resumption-time-point computation block 275. Thus, the operation to electrically charge the secondary battery 3 is resumed at the electrical-charging resumption time point Ts.

The electrical-charging control block 276 determines how the secondary battery 3 is to be electrically charged on the basis of inputs entered by the user by operating the input section 12, a residual electric charge amount detected by the battery residual electric-charge amount detection block 271 as the amount of residual electric charge left in the secondary battery 3 and the electrical-charging end time point Tf. Then, the electrical-charging control block 276 supplies a control signal determined in advance to the switch section 22 in order to control an operation carried out to put the switch section 22 in a turned-on or turned-off state. Details of electrical charging processing including the operation carried out to put the switch section 22 in a turned-on or turned-off state will be described later.

The configuration of the secondary-battery electrically charging apparatus 1 for electrically charging the secondary battery 3 employed in the electronic apparatus 2 has been described above. In this embodiment, the operation to electrically charge the secondary battery 3 is a constant-current operation carried out to electrically charge the secondary battery 3 by making use of an electrical-charging current determined in advance. However, the operation to electrically charge the secondary battery 3 does not have to be the constant-current operation. For example, the operation to electrically charge the secondary battery 3 can be a constant-current constant-voltage operation which is a combination of the constant-current operation to electrically charge the secondary battery 3 and a constant-voltage operation to electrically charge the secondary battery 3. As an alternative, the operation to electrically charge the secondary battery 3 may adopt a pulse electrical charging method.

Operations of the Secondary-Battery Electrically Charging Apparatus

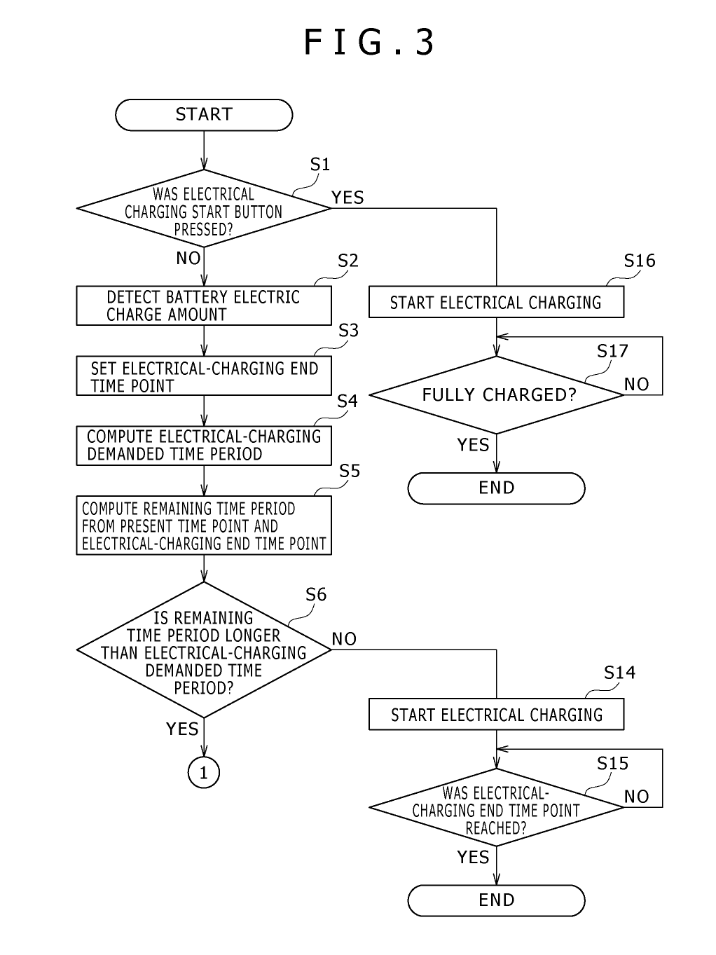

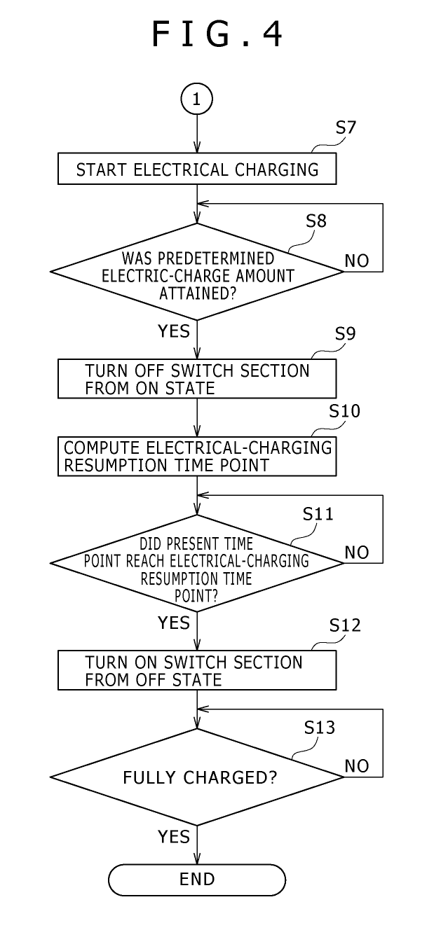

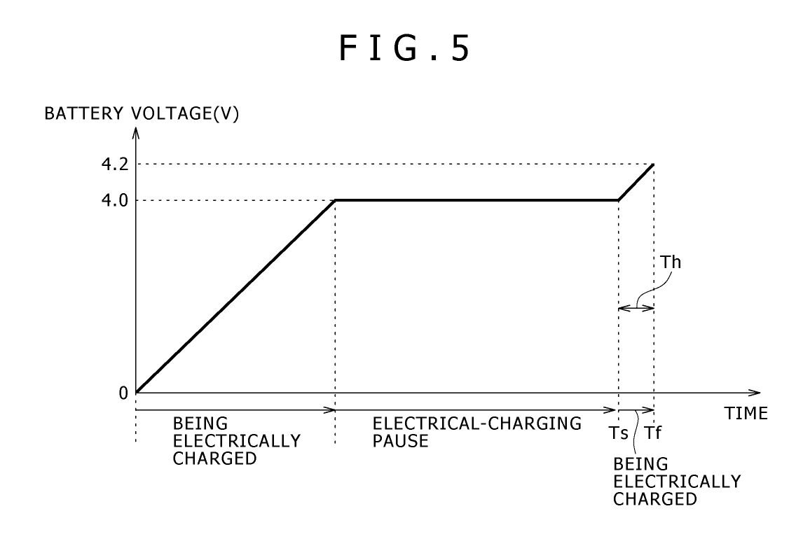

By referring to flowcharts shown in FIGS. 3 and 4 as well as a graph shown in a diagram which serves as FIG. 5, the following description explains a secondary-battery electrically charging method adopted by the secondary-battery electrically charging apparatus 1 having a configuration described above.

First of all, when the electronic apparatus 2 employing the secondary battery 3 is mounted on the secondary-battery electrically charging apparatus 1 in order to connect the secondary battery 3 employed in the electronic apparatus 2 to the secondary-battery electrically charging apparatus 1, as shown in the flowchart shown in FIG. 3, execution of the procedure of the secondary-battery electrically charging method is started at a step S1 in order to produce a result of determination as to whether or not the user has pressed the electrical charging start button 123. If the determination result produced at the step S1 is NO indicating that the user has not pressed the electrical charging start button 123, the flow of the procedure of the secondary-battery electrically charging method goes on to a step S2. At the step S2, the battery residual electric-charge amount detection block 271 detects the amount of residual electric charge stored in the secondary battery 3. Then, at the next step S3, the electrical-charging end time-point setting block 272 sets the electrical-charging end point of time Tf on the basis of inputs entered by the user by operating the input section 12. The electrical-charging end time-point setting block 272 then stores the electrical-charging end time point Tf in the storage section 26.

Subsequently, at the next step S4, the electrical-charging demanded time-period computation block 273 computes an electrical-charging demanded time period Tr from a residual electric charge amount detected by the battery residual electric-charge amount detection block 271 at the start of an operation to electrically charge the secondary battery 3 as the amount of residual electric charge stored in the secondary battery 3. The electrical-charging demanded time period Tr is the length of time it takes to electrically charge the secondary battery 3 to a state of being electrically charged to the full electric-charge storage capacity of the secondary battery 3 from an initial state. In the first embodiment, at the time point at which the electronic apparatus 2 employing the secondary battery 3 is mounted on the secondary-battery electrically charging apparatus 1 in order to connect the secondary battery 3 employed in the electronic apparatus 2 to the secondary-battery electrically charging apparatus 1, the secondary battery 3 is assumed to be all but empty or the amount of residual electric charge stored in the secondary battery 3 in the initial state is assumed to be all but zero, and the electrical-charging demanded time period Tr ending at the state in which the secondary battery 3 is electrically charged from the initial state to the full electric-charge storage capacity of the secondary battery 3 is assumed to be four hours.

Then, at the next step S5, the remaining time-period computation block 274 computes the remaining time period Tz from a difference between the present time point Tn and the electrical-charging end point of time Tf by subtracting the present time point Tn from the electrical-charging end time point Tf in accordance with the following equation Tz=Tf−Tn. Subsequently, the flow of the procedure of the secondary-battery electrically charging method goes on to the next step S6 at which the remaining time period Tz is compared with the electrical-charging demanded time period Tr in order to produce a result of determination as to whether or not the remaining time period Tz is longer than the electrical-charging demanded time period Tr. If the determination result produced at the step S6 is YES indicating that the remaining time period Tz is longer than the electrical-charging demanded time period Tr, the flow of the procedure of the secondary-battery electrically charging method goes on to a step S7 of the flowchart shown in FIG. 4. As an example, let us assume a case in which the present time point Tn is 1:00 AM and the electrical-charging end time point Tf set on the basis of inputs entered by the user by operating the input section 12 is 7:00 AM. In this case, the remaining time period Tz has a length of six hours which are the length of time between the present time point Tn of 1:00 AM and the electrical-charging end time point Tf of 7:00 AM. Since the remaining time period Tz of six hours is long in comparison with the electrical-charging demanded time period Tr of four hours, the flow of the procedure of the secondary-battery electrically charging method goes on to the step S7 at which the operation to electrically charge the secondary battery 3 is carried out in the first electrical-charging mode cited before.

At the step S7, the operation to electrically charge the secondary battery 3 in the first electrical-charging mode is started. Then, the flow of the procedure of the secondary-battery electrically charging method goes on to the next step S8 in order to produce a result of determination as to whether or not the secondary battery 3 has been electrically charged till the amount of electric charge stored in the secondary battery 3 attains an electric-charge amount determined in advance. For example, the voltage appearing on the secondary battery 3 is examined in order to produce a result of determination as to whether or not the voltage appearing on the secondary battery 3 has reached a voltage which corresponds to the electric-charge amount determined in advance. The result of determination as to whether or not the voltage appearing on the secondary battery 3 has reached a voltage corresponding to the electric-charge amount determined in advance can be regarded as a result of determination as to whether or not the secondary battery 3 has been electrically charged till the amount of electric charge stored in the secondary battery 3 attains the electric-charge amount determined in advance. However, the method is by no means limited to the production of the result of determination as to whether or not the voltage appearing on the secondary battery 3 has reached a voltage corresponding to the electric-charge amount determined in advance. In this embodiment, the voltage appearing on the secondary battery 3 as a voltage corresponding to the electric-charge amount determined in advance is set at 4.0 V. However, the voltage appearing on the secondary battery 3 as a voltage corresponding to the electric-charge amount determined in advance is by no means limited to 4.0 V. That is to say, the voltage appearing on the secondary battery 3 as a voltage corresponding to the electric-charge amount determined in advance can be set at any value as long as the value is equal to or greater than a lower limit corresponding to the amount of electric charge stored in the secondary battery 3 as electric charge making the secondary battery 3 usable but is equal to or smaller than an upper limit of 4.2 V which is the level of the voltage appearing on the secondary battery 3 already put in a state of being electrically charged to the full electric-charge storage capacity of the secondary battery 3. If the determination result produced at the step S8 is NO indicating that the voltage appearing on the secondary battery 3 is lower than 4.0 V, the flow of the procedure of the secondary-battery electrically charging method goes back to the step S8 in order to repeat the determination process of the step S8. The determination process of the step S8 is carried out repeatedly till the voltage appearing on the secondary battery 3 becomes equal to 4.0 V as shown in FIG. 5. As the determination result produced at the step S8 is YES indicating that the voltage appearing on the secondary battery 3 is equal to 4.0 V which is the level of a voltage corresponding to the electric-charge amount determined in advance, on the other hand, the flow of the procedure of the secondary-battery electrically charging method goes on to the next step S9.

At the step S9, the control section 27 outputs a control signal to the switch section 22 in order to change the state of the switch section 22 from a turned-on state to a turned-off state. Thus, the switch section 22 is put in a turned-off state. As a result, the operation to supply an electrical-charging current to the secondary battery 3 is stopped and put in the state of a temporary electrical-charging pause as shown in a diagram which serves as FIG. 5. That is to say, the operation to supply an electrical-charging current to the secondary battery 3 is temporarily halted, preventing the secondary battery 3 from being left uncontrolled in a state of being electrically charged to the full electric-charge storage capacity of the secondary battery 3 in the operation to electrically charge the secondary battery 3.

Then, at the next step S10, the electrical-charging resumption-time-point computation block 275 computes an electrical-charging resumption time-point Ts by subtracting the post-resumption electrical-charging demanded time period Th from the electrical-charging end time point Tf in accordance with the following equation Ts=Tf−Th. The post-resumption electrical-charging demanded time period Th is the length of time it takes to electrically charge the secondary battery 3 till the voltage appearing on the secondary battery 3 changes from 4.0 V to a level corresponding to the state of being electrically charged to the full electric-charge storage capacity of the secondary battery 3 on the assumption that the operation to electrically charge the secondary battery 3 is an operation resumed from a state in which the voltage appearing on the secondary battery 3 has been put at 4.0 V.

Then, the flow of the procedure of the secondary-battery electrically charging method goes on to the next step S11 at which the present time point Tn is compared with the electrical-charging resumption time point Ts in order to produce a result of determination as to whether or not the present time point Tn has reached the electrical-charging resumption time-point Ts. If the determination result produced at the step S11 is NO indicating that the present time point Tn has not reached the electrical-charging resumption time-point Ts, the flow of the procedure of the secondary-battery electrically charging method goes back to the step S11 in order to repeat the determination process of the step S11. As a matter of fact, the determination process of the step S11 is carried out repeatedly as long as the determination result produced at the step S11 is NO. In this way, while the determination process of the step S11 is being carried out repeatedly, the state of the temporary electrical-charging pause of the operation to electrically charge the secondary battery 3 is sustained. As the determination result produced at the step S11 becomes YES indicating that the present time point Tn has reached the electrical-charging resumption time-point Ts, on the other hand, the flow of the procedure of the secondary-battery electrically charging method goes on to the next step S12.

At the step S12, the control section 27 outputs a control signal to the switch section 22 in order to change the state of the switch section 22 from a turned-off state to a turned-on state. As a result, the operation to supply an electrical-charging current to the secondary battery 3 is started. That is to say, the operation to supply an electrical-charging current to the secondary battery 3 is resumed. Then, the flow of the procedure of the secondary-battery electrically charging method goes on to the next step S13 in order to produce a result of determination as to whether or not the secondary battery 3 has been electrically charged to the full electric-charge storage capacity of the secondary battery 3. If the determination result produced at the step S13 is NO indicating that the secondary battery 3 has not been electrically charged to the full electric-charge storage capacity of the secondary battery 3, the flow of the procedure of the secondary-battery electrically charging method goes back to the step S13 in order to repeat the determination process of the step S13. As a matter of fact, the determination process of the step S13 is carried out repeatedly as long as the determination result produced at the step S13 is NO. In this way, while the determination process of the step S13 is being carried out repeatedly, the secondary battery 3 is electrically charged to the full electric-charge storage capacity of the secondary battery 3 as shown in the diagram which serves as FIG. 5. As the determination result produced at the step S13 becomes YES indicating that the secondary battery 3 has been electrically charged to the full electric-charge storage capacity of the secondary battery 3, on the other hand, the procedure of the secondary-battery electrically charging method is terminated. It is to be noted that, in accordance with the present embodiment, the secondary battery 3 is electrically charged to achieve the full electric-charge storage capacity of the secondary battery 3 at the electrical-charging end time point Tf. Thus, the determination process can be carried out at the step S13 by typically comparing the present time point Tn with the electrical-charging end time point Tf in order to produce a result of determination as to whether or not the present time point Tn has reached the electrical-charging end time point Tf. That is to say, as the present time point Tn reaches the electrical-charging end time point Tf, the procedure of the secondary-battery electrically charging method is terminated.

As described above, in the first electrical-charging mode according to the first embodiment, when the electronic apparatus 2 employing the secondary battery 3 is mounted on the secondary-battery electrically charging apparatus 1 in order to connect the secondary battery 3 employed in the electronic apparatus 2 to the secondary-battery electrically charging apparatus 1, first of all, the secondary battery 3 is electrically charged till the amount of electric charge stored in the secondary battery 3 reaches a predetermined amount of electric charge. That is to say, the secondary battery 3 is electrically charged till the voltage appearing on the secondary battery 3 reaches a predetermined level lower than a level at which the secondary battery 3 has been electrically charged to the full electric-charge storage capacity of the secondary battery 3. Thus, the user can make use of the electronic apparatus 2 employing the secondary battery 3 right after the electronic apparatus 2 has been mounted on the secondary-battery electrically charging apparatus 1 in order to connect the secondary battery 3 employed in the electronic apparatus 2 to the secondary-battery electrically charging apparatus 1. In addition, the operation to electrically charge the secondary battery 3 till the voltage appearing on the secondary battery 3 reaches the level determined in advance is temporarily stopped to be resumed again as the present time point Tn reaches the electrical-charging resumption time point Ts. Thus, it is possible to prevent the secondary battery 3 from being left uncontrolled in a state of being electrically charged to the full electric-charge storage capacity of the secondary battery 3 in the operation to electrically charge the secondary battery 3 and, at the same time, it is possible to electrically charge the secondary battery 3 to achieve the full electric-charge storage capacity of the secondary battery 3 at the electrical-charging end time point Tf set on the basis of inputs entered by the user by operating the input section 12 as a time point at which the secondary battery 3 should just be put in a state of being electrically charged to the full electric-charge storage capacity of the secondary battery 3. As a result, it is possible to satisfy two conditions which are contradictory to each other as described as follows. The first condition demands that an attempt be made as far as possible not to electrically charge the secondary battery 3 to a state of being electrically charged to the full electric-charge storage capacity of the secondary battery 3 in order to prolong the life of the secondary battery 3. On the other hand, the second condition demands that the secondary battery 3 be put always in a state of being electrically charged to achieve the full electric-charge storage capacity of the secondary battery 3 in an operation to electrically charge the secondary battery 3 at a time desired by the user in order to provide the user with convenience.

If the determination result produced at the step S6 is NO indicating that the remaining time period Tz is shorter than the electrical-charging demanded time period Tr, on the other hand, the flow of the procedure of the secondary-battery electrically charging method goes on to a step S14. As an example, let us assume a case in which the present time point Tn is 4:00 AM and the electrical-charging end time point Tf set on the basis of inputs entered by the user by operating the input section 12 is 7:00 AM. In this case, the remaining time period Tz has a length of three hours which are the length of time between the present time point Tn is of 4:00 AM and the electrical-charging end time point Tf of 7:00 AM. Since the remaining time period Tz of three hours is short in comparison with the electrical-charging demanded time period Tr of four hours, the flow of the procedure of the secondary-battery electrically charging method goes on to the step S14 in order to carry out the operation to electrically charge the secondary battery 3 in a second electrical-charging mode.

At the step S14, the operation to electrically charge the secondary battery 3 in the second electrical-charging mode is started. Then, the flow of the procedure of the secondary-battery electrically charging method goes on to the next step S15 at which the present time point Tn is compared with the electrical-charging end time point Tf in order to produce a result of determination as to whether or not the present time point Tn has reached the electrical-charging end time point Tf. If the determination result produced at the step S15 is NO indicating that the present time point Tn has not reached the electrical-charging end time point Tf, the flow of the procedure of the secondary-battery electrically charging method goes back to the step S15 in order to repeat the determination process of the step S15. As a matter of fact, the determination process of the step S15 is carried out repeatedly as long as the determination result produced at the step S15 is NO. That is to say, the determination process of the step S15 is carried out repeatedly till the present time point Tn reaches the electrical-charging end time point Tf. As the determination result produced at the step S15 becomes YES indicating that the present time point Tn has reached the electrical-charging end time point Tf, on the other hand, the procedure of the secondary-battery electrically charging method is terminated.

The operation to electrically charge the secondary battery 3 is carried out in the second electrical-charging mode at the steps S14 and S15 as described above if the remaining time period Tz is shorter than the electrical-charging demanded time period Tr. The operation to electrically charge the secondary battery 3 is started right after the electronic apparatus 2 employing the secondary battery 3 has been mounted on the secondary-battery electrically charging apparatus 1 in order to connect the secondary battery 3 employed in the electronic apparatus 2 to the secondary-battery electrically charging apparatus 1. In this case, since the operation to electrically charge the secondary battery 3 is carried out for the remaining time period Tz having a three-hour length which is short in comparison with the electrical-charging demanded time period Tr of four hours, however, the operation to electrically charge the secondary battery 3 is terminated before the amount of electric charge stored in secondary battery 3 in the operation attains the full electric-charge storage capacity of the secondary battery 3.

If the determination result produced at the step S1 is YES indicating that the user has pressed the electrical charging start button 123, on the other hand, the flow of the procedure of the secondary-battery electrically charging method goes on to a step S16. At the step S16, the operation to electrically charge the secondary battery 3 is started. Then, the flow of the procedure of the secondary-battery electrically charging method goes on to the next step S17 in order to produce a result of determination as to whether or not the secondary battery 3 has been electrically charged to the full electric-charge storage capacity of the secondary battery 3. If the determination result produced at the step S17 is NO indicating that the secondary battery 3 has not been electrically charged to the full electric-charge storage capacity of the secondary battery 3, the flow of the procedure of the secondary-battery electrically charging method goes back to the step S17 in order to repeat the determination process of the step S17. As a matter of fact, the determination process of the step S17 is carried out repeatedly as long as the determination result produced at the step S17 is NO. In this way, while the determination process of the step S17 is being carried out repeatedly, the secondary battery 3 is electrically charged to the full electric-charge storage capacity of the secondary battery 3. As the determination result produced at the step S17 becomes YES indicating that the secondary battery 3 has been electrically charged to the full electric-charge storage capacity of the secondary battery 3, on the other hand, the procedure of the secondary-battery electrically charging method is terminated. The operation to electrically charge the secondary battery 3 is carried out in a third electrical-charging mode at the steps S16 and S17 when the user presses the electrical-charging start button 123 in order to enter a command to start the operation. When the user enters a command to start the operation to electrically charge the secondary battery 3, the operation is started right away forcibly to the full electric-charge storage capacity of the secondary battery by ignoring the remaining time period Tz and the electrical-charging end time point Tf even if the electrical-charging end time point Tf has been set by the user by operating the input section 12. Thus, the secondary-battery electrically charging apparatus 1 is adapted to a case in which the user is in a hurry and a case in which the user wants to make use of the secondary-battery electrically charging apparatus 1 as an ordinary electrically-charging apparatus.

### 2: Second Embodiment

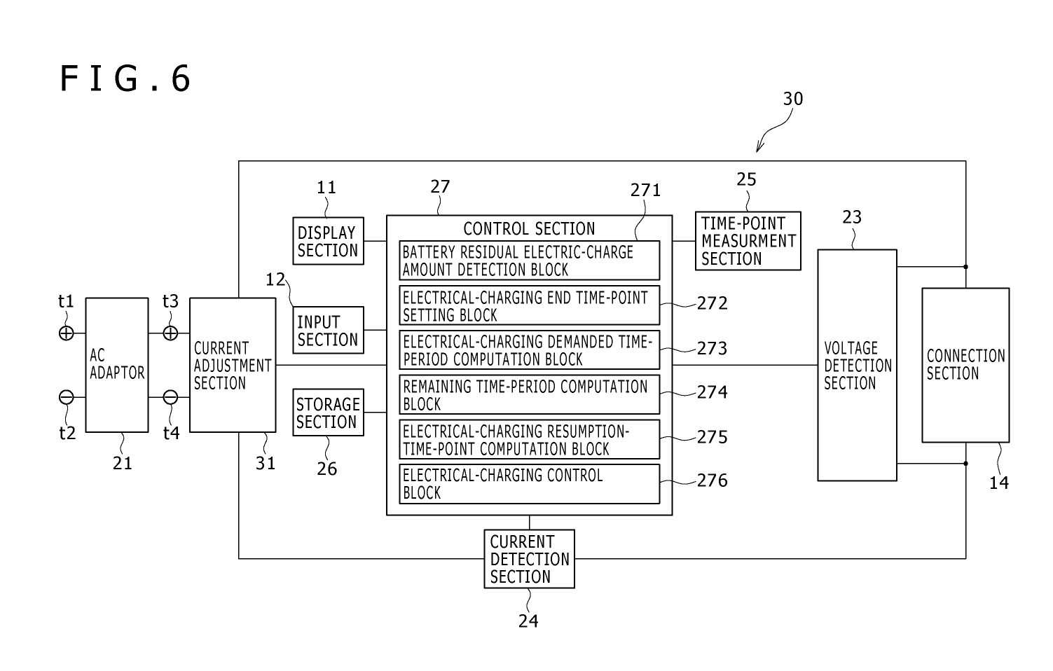

A second embodiment is explained by referring to FIGS. 6 to 8 as follows. It is to be noted that, in the second embodiment, configuration elements identical with their respective counterparts employed in the first embodiment are denoted by the same reference symbols as the counterparts and the identical configuration elements are not described again in order to avoid duplications of explanations.

Configuration of an Electrical Charging Circuit

FIG. 6 is a block diagram showing the configuration of an electrical charging circuit 30 employed in a secondary-battery electrically charging apparatus 1 according to the second embodiment. A current adjustment section 31 is connected to an AC adaptor 21. The current adjustment section 31 is a section for adjusting the magnitude of an electrical-charging current supplied to the secondary battery 3 in accordance with a control signal received from an electrical-charging control block 276 employed in a control section 27. By adjusting the magnitude of the electrical-charging current, the speed of the operation to electrically charge the secondary battery 3 can be controlled. The magnitude of the electrical-charging current is controlled by typically adjusting the pulse width of the electrical-charging current in accordance with a control signal received from the electrical-charging control block 276 employed in the control section 27. The electrical charging circuit 30 employed in the second embodiment is different from the electrical charging circuit 20 employed in the first embodiment in that the electrical charging circuit 30 does not have the switch section 22 but includes the current adjustment section 31 instead.

The control section 27 executes control programs determined in advance, functioning as the battery residual electric-charge amount detection block 271, the electrical-charging end time-point setting block 272, the electrical-charging demanded time-period computation block 273, the remaining time-period computation block 274, the electrical-charging resumption-time-point computation block 275 and the electrical-charging control block 276. As described above, the electrical-charging control block 276 employed in the second embodiment outputs a control signal determined in advance to the current adjustment section 31 which then adjusts the magnitude of the electrical-charging current in accordance with the control signal.

It is to be noted that the external appearance of the secondary-battery electrically charging apparatus 1 also configured to serve as an electrical charging base for an electronic apparatus 2 in the second embodiment is identical with the external appearance of the secondary-battery electrically charging apparatus 1 according to the first embodiment.

Operations of the Electrically Charging Apparatus

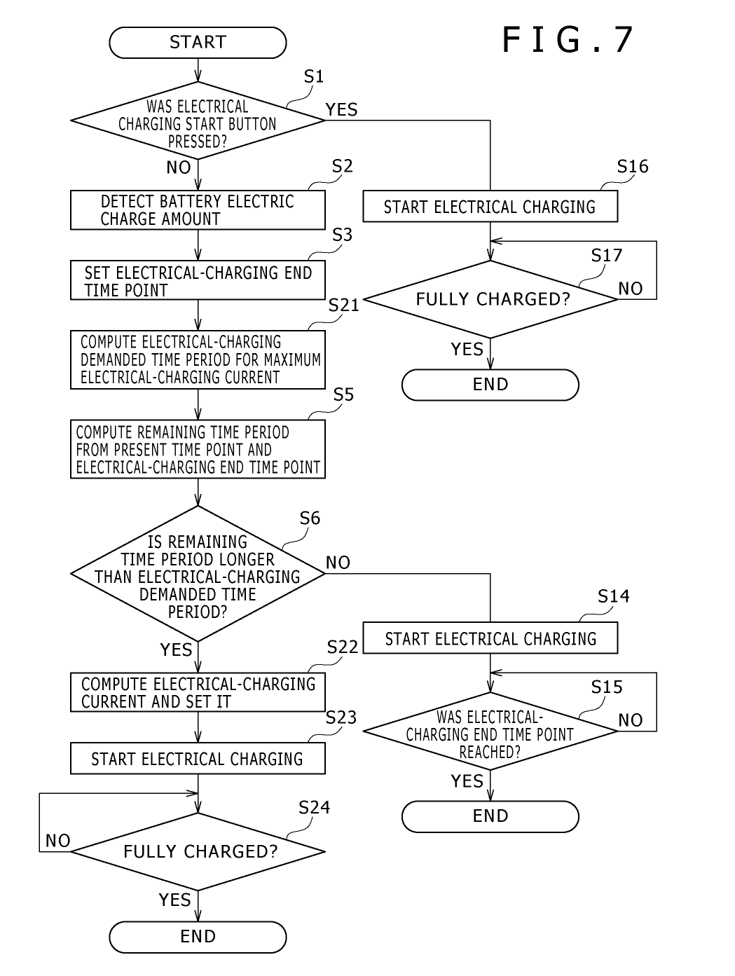

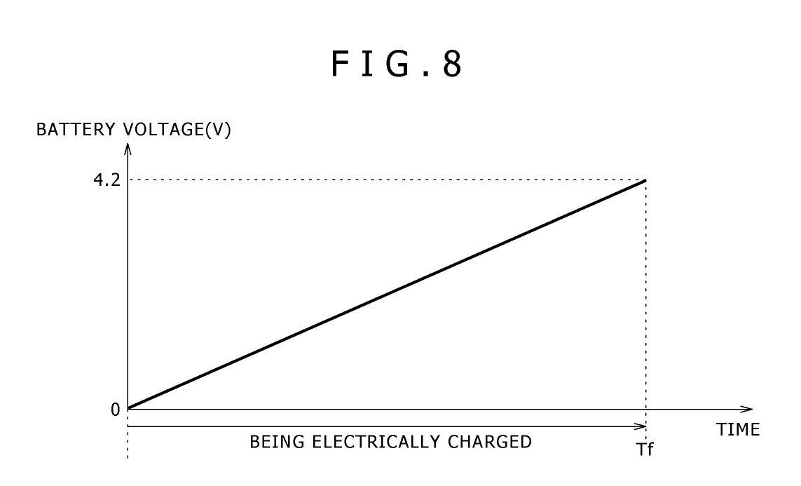

By referring to a flowchart shown in FIG. 7 and a graph shown in a diagram which serves as FIG. 8, the following description explains a secondary-battery electrically charging method adopted by the secondary-battery electrically charging apparatus 1 according to the second embodiment having a configuration described above. It is to be noted that, in the same way as the first embodiment, the processes of the steps S14 and S15 are carried out in the second electrical-charging mode whereas the processes of the steps S16 and S17 are carried out in the third electrical-charging mode. For this reason, the steps S14, S15, S16 and S17 are not explained again in order to avoid duplications of explanations.

First of all, when the electronic apparatus 2 employing the secondary battery 3 is mounted on the secondary-battery electrically charging apparatus 1 in order to connect the secondary battery 3 employed in the electronic apparatus 2 to the secondary-battery electrically charging apparatus 1, as shown in the flowchart shown in FIG. 7, execution of the secondary-battery electrically charging method is started at a step S1 in order to produce a result of determination as to whether or not the user has pressed the electrical charging start button 123. If the determination result produced at the step S1 is NO indicating that the user has not pressed the electrical charging start button 123, the flow of the procedure of the secondary-battery electrically charging method goes on to a step S2. At the step S2, the battery residual electric-charge amount detection block 271 detects the amount of residual electric charge stored in the secondary battery 3. Then, at the next step S3, the electrical-charging end time-point setting block 272 sets the electrical-charging end point of time Tf on the basis of inputs entered by the user by operating the input section 12.

Subsequently, at the next step S21, on the assumption that a largest electrical-charging current generated by the current adjustment section 31 employed in the secondary-battery electrically charging apparatus 1 is flowing through the secondary battery 3 as a current used for electrically charging the secondary battery 3, the electrical-charging demanded time-period computation block 273 computes an electrical-charging demanded time period Tr from a residual electric charge amount detected at the start of an operation to electrically charge the secondary battery 3 as the amount of residual electric charge stored in the secondary battery 3. The electrical-charging demanded time period Tr is the length of time it takes to electrically charge the secondary battery 3 to a state of being electrically charged to the full electric-charge storage capacity of the secondary battery 3 from an initial state in which the secondary battery 3 still contains residual electric charge of an electrical-charge amount equal to the residual electric charge amount detected at the step S2. Then, at the next step S5, the remaining time-period computation block 274 computes the remaining time period Tz from a difference between the present time point Tn and the electrical-charging end point of time Tf by subtracting the present time point Tn from the electrical-charging end time point Tf in accordance with the following equation Tz=Tf−Tn. Subsequently, the flow of the procedure of the secondary-battery electrically charging method goes on to the next step S6 at which the remaining time period Tz is compared with the electrical-charging demanded time period Tr in order to produce a result of determination as to whether or not the remaining time period Tz is longer than the electrical-charging demanded time period Tr. If the determination result produced at the step S6 is YES indicating that the remaining time period Tz is longer than the electrical-charging demanded time period Tr, the flow of the procedure of the secondary-battery electrically charging method goes on to a step S22.

At the step S22, on the basis of the residual electric charge amount detected at the step S2 as the amount of residual electric charge stored in the secondary battery 3 and the electrical-charging end time point Tf set at the step S3, the current adjustment section 31 computes the magnitude of an electrical-charging current to be used in an operation carried out to electrically charge the secondary battery 3 to achieve the full electric-charge storage capacity of the secondary battery 3 at the electrical-charging end time point Tf provided that the operation is started at the present time point Tn. Then, the current adjustment section 31 sets an electrical-charging current at the computed magnitude as a current to flow to the secondary battery 3 in response to a control signal output by the control section 27 to the current adjustment section 31 to serve as a control signal for adjusting the electrical-charging current.

At the next step S23, the operation to electrically charge the secondary battery 3 by making use of the electrical-charging current set at the step S22 is started. Then, the flow of the procedure of the secondary-battery electrically charging method goes on to the next step S24 in order to produce a result of determination as to whether or not the secondary battery 3 has been electrically charged to the full electric-charge storage capacity of the secondary battery 3. If the determination result produced at the step S24 is NO indicating that the secondary battery 3 has not been electrically charged to the full electric-charge storage capacity of the secondary battery 3, the flow of the procedure of the secondary-battery electrically charging method goes back to the step S24 in order to repeat the determination process of the step S24. As a matter of fact, the determination process of the step S24 is carried out repeatedly as long as the determination result produced at the step S24 is NO. As the determination result produced at the step S24 becomes YES indicating that the secondary battery 3 has been electrically charged to the full electric-charge storage capacity of the secondary battery 3, on the other hand, the procedure of the secondary-battery electrically charging method is terminated. Instead of producing a result of determination as to whether or not the secondary battery 3 has been electrically charged to the full electric-charge storage capacity of the secondary battery 3 at the step S24, the determination process can be carried out at the step S24 by typically comparing the present time point Tn with the electrical-charging end time point Tf in order to produce a result of determination as to whether or not the present time point Tn has reached the electrical-charging end time point Tf in the same way as the steps S13 and S17 in the first embodiment. For the sake of convenience, the operation carried out at the steps S22 to S24 to electrically charge the secondary battery 3 by making use of an electrical-charging current with an adjusted magnitude is referred to as an operation carried out at a fourth electrical-charging mode.

As described above, in the fourth electrical-charging mode, when the electronic apparatus 2 employing the secondary battery 3 is mounted on the secondary-battery electrically charging apparatus 1 in order to connect the secondary battery 3 employed in the electronic apparatus 2 to the secondary-battery electrically charging apparatus 1, the current adjustment section 31 computes the magnitude of an electrical-charging current to be used in an operation carried out to electrically charge the secondary battery 3 to achieve the full electric-charge storage capacity of the secondary battery 3 at the electrical-charging end time point Tf provided that the operation is started at the present time point Tn. Thus, the user can make use of the electronic apparatus 2 employing the secondary battery 3 right after the electronic apparatus 2 has been mounted on the secondary-battery electrically charging apparatus 1 in order to connect the secondary battery 3 employed in the electronic apparatus 2 to the secondary-battery electrically charging apparatus 1. In addition, the operation to electrically charge the secondary battery 3 is carried out by making use of an electrical-charging current, the magnitude of which is so adjusted that the secondary battery 3 is electrically charged to achieve the full electric-charge storage capacity of the secondary battery 3 at the electrical-charging end time point Tf. Thus, it is possible to prevent the secondary battery 3 from being left uncontrolled in a state of being electrically charged to the full electric-charge storage capacity of the secondary battery 3 in the operation to electrically charge the secondary battery 3 and, at the same time, it is possible to electrically charge the secondary battery 3 to achieve the full electric-charge storage capacity of the secondary battery 3 at the electrical-charging end time point Tf set on the basis of inputs entered by the user by operating the input section 12 as a time point at which the secondary battery 3 should just be put in a state of being electrically charged to the full electric-charge storage capacity of the secondary battery 3. As a result, it is possible to satisfy two conditions which are contradictory to each other as described as follows. The first condition demands that an attempt be made as far as possible not to electrically charge the secondary battery 3 to a state of being electrically charged to the full electric-charge storage capacity of the secondary battery 3 in order to prolong the life of the secondary battery 3. On the other hand, the second condition demands that the secondary battery 3 be put always in a state of being electrically charged to achieve the full electric-charge storage capacity of the secondary battery 3 in an operation to electrically charge the secondary battery 3 at a time desired by the user in order to provide the user with convenience.

### 3: Modified Versions

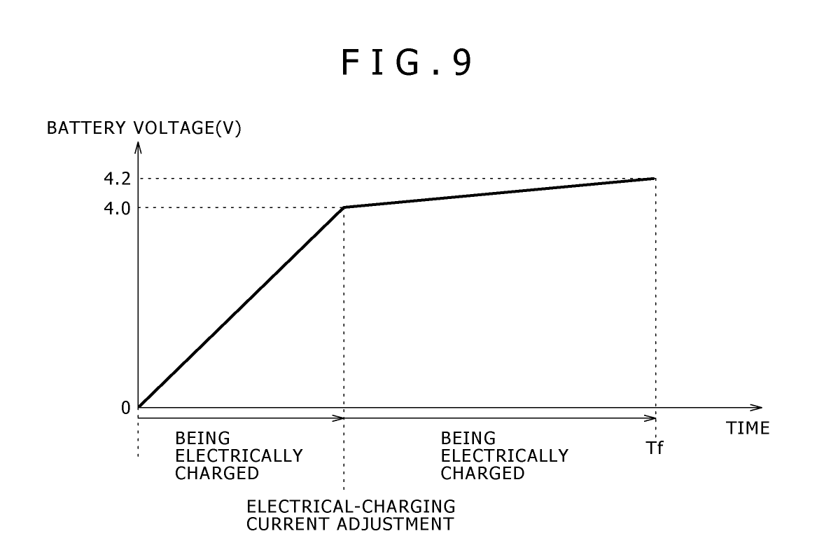

As shown in FIG. 9, the secondary battery 3 can be electrically charged to achieve the full electric-charge storage capacity of the secondary battery 3 at the electrical-charging end time point Tf by changing the magnitude of the electrical-charging current in the course of the operation to electrically charge the secondary battery 3. In accordance with the secondary-battery electrically charging apparatus according to this modified version, first of all, the secondary battery 3 is electrically charged to a predetermined electric-charge storage capacity of the secondary battery 3 by making use of an electrical-charge current determined in advance. Then, at a particular point of time in the course of the operation to electrically charge the secondary battery 3 to the predetermined electric-charge storage capacity of the secondary battery 3, the magnitude of the electrical-charge current determined in advance is changed to a reduced value. After the magnitude of the electrical-charge current determined in advance is changed to the reduced value, the operation to electrically charge the secondary battery 3 is continued during the remaining time period Tz which can be computed by subtracting the particular point of time from the electrical-charging end time point Tf. The magnitude of the electrical-charge current determined in advance is changed to the reduced value which is adjusted in accordance with the remaining time period Tz so that the secondary battery 3 is electrically charged to achieve the full electric-charge storage capacity of the secondary battery 3 at the electrical-charging end time point Tf.

Also in accordance with the secondary-battery electrically charging method adopted by the secondary-battery electrically charging apparatus according to this modified version, the user can make use of the electronic apparatus 2 employing the secondary battery 3 right after the electronic apparatus 2 has been mounted on the secondary-battery electrically charging apparatus 1 in order to connect the secondary battery 3 employed in the electronic apparatus 2 to the secondary-battery electrically charging apparatus 1. In addition, it is possible to satisfy two conditions which are contradictory to each other as described as follows. The first condition demands that an attempt be made as far as possible not to electrically charge the secondary battery 3 to a state of being electrically charged to the full electric-charge storage capacity of the secondary battery 3 in order to prolong the life of the secondary battery 3. On the other hand, the second condition demands that the secondary battery 3 be put always in a state of being electrically charged to achieve the full electric-charge storage capacity of the secondary battery 3 in an operation to electrically charge the secondary battery 3 at a time desired by the user in order to provide the user with convenience.

The operation to electrically charge the secondary battery 3 is carried out in the second electrical-charging mode in the first embodiment if the remaining time period Tz is shorter than the electrical-charging demanded time period Tr as described above. The operation to electrically charge the secondary battery 3 is started right after the electronic apparatus 2 employing the secondary battery 3 has been mounted on the secondary-battery electrically charging apparatus 1 in order to connect the secondary battery 3 employed in the electronic apparatus 2 to the secondary-battery electrically charging apparatus 1. In this second electrical-charging mode, as described above, since the operation to electrically charge the secondary battery 3 is carried out for the remaining time period Tz which is short in comparison with the electrical-charging demanded time period Tr, however, the operation to electrically charge the secondary battery 3 is terminated before the amount of electric charge stored in secondary battery 3 in the operation attains the full electric-charge storage capacity of the secondary battery 3. In order to solve this problem, a current adjustment section 31 like the one employed in the second embodiment can also be provided in the first embodiment. With the current adjustment section 31 employed in the first embodiment, the magnitude of the electrical-charging current can be increased by the current adjustment section 31 in order to carry out the operation to electrically charge the secondary battery 3 at a high speed. Thus, also in the second electrical-charging mode, the secondary battery 3 can be electrically charged to achieve the full electric-charge storage capacity of the secondary battery 3 by the electrical-charging end time point Tf.

In addition, also in the third electrical-charging mode of the first embodiment modified to include the current adjustment section 31 as described above, the magnitude of the electrical-charging current can be increased by the current adjustment section 31 in order to carry out a particular fast operation to electrically charge the secondary battery 3 at a high speed. That is to say, the current adjustment operation performed by the current adjustment section 31 to adjust the magnitude of the electrical-charging current is not limited to the ordinary operation carried out to electrically charge the secondary battery 3 in the first or second electrical-charging mode.

On top of that, the input section 12 can be further provided with a button used for specifying a day of the week. With the button provided in the input section 12 to serve as a button used for specifying a day of the week, it is possible to set an electrical-charging end time point Tf for each day of the week. Then, the electrical-charging end time point Tf set for each day of the week is stored in the storage section 26 and the operation to electrically charge the secondary battery 3 for any specific day of the week is carried out in accordance with an electrical-charging end time point Tf stored in the storage section 26 as an electrical-charging end time point Tf associated with the specific day. Thus, it is possible to carry out the operation to electrically charge the secondary battery 3 as an operation which matches the rhythm of the life of the user. As an example, for the week days Monday to Friday on which the user must leave home in the morning, the electrical-charging end time point Tf can be set at 7:00 AM. For the week ends Saturday to Sunday on which the user does not have to leave home in the morning, on the other hand, the electrical-charging end time point Tf can be set at 12:00 AM. Thus, it is possible to get rid of the complicacy entailed by the necessity to set the electrical-charging end time point Tf everyday. In addition, instead of setting an electrical-charging end time point Tf for each day of the week, it is also possible to set an electrical-charging end time point Tf for each day of a month. On top of that, it is also possible to set a plurality of electrical-charging end point of times Tf for a day.

The descriptions given so far have explained a typical secondary-battery electrically charging apparatus 1 which is configured to serve as an electrical charging base for an electronic apparatus 2. However, the secondary-battery electrically charging apparatus 1 does not have to be configured to serve as an electrical charging base for an electronic apparatus 2. For example, the secondary-battery electrically charging apparatus 1 can also be configured to have a box shape. In the case of a secondary-battery electrically charging apparatus 1 configured to have a box shape, the secondary battery 3 is set in the secondary-battery electrically charging apparatus 1 which is connected to a consent. That is to say, the secondary-battery electrically charging apparatus 1 can also be configured to serve as an ordinary electrical charger for electrically charging the secondary battery 3.

In the first and second embodiments described above, the electrical charging circuit 20 for electrically charging the secondary battery 3 is put in the secondary-battery electrically charging apparatus 1 on the electrical charging side. However, it is also possible to provide a configuration in which the electrical charging circuit 20 is provided on the side on which the electronic apparatus 2 is placed.

In addition, in accordance with the electrical charging method adopted in the first and second embodiments described above, the secondary-battery electrically charging apparatus 1 and the electronic apparatus 2 employing the secondary battery 3 are connected to each other by making use of a connector and the secondary battery 3 is electrically charged with electric power supplied from the secondary-battery electrically charging apparatus 1 to the electronic apparatus 2 by way of the connector. However, implementations are by no means limited to this electrical charging method which makes use of a connector. That is to say, a noncontact electrical charging method can also be adopted. In accordance with the noncontact electrical charging method, power is typically transferred from the secondary-battery electrically charging apparatus to the electronic apparatus by making use of electromagnetic induction between two coils employed in the secondary-battery electrically charging apparatus and the electronic apparatus respectively. Thus, by adopting the noncontact electrical charging method, the secondary battery can be electrically charged without making use of a contact point such as a contact point between metallic portions.

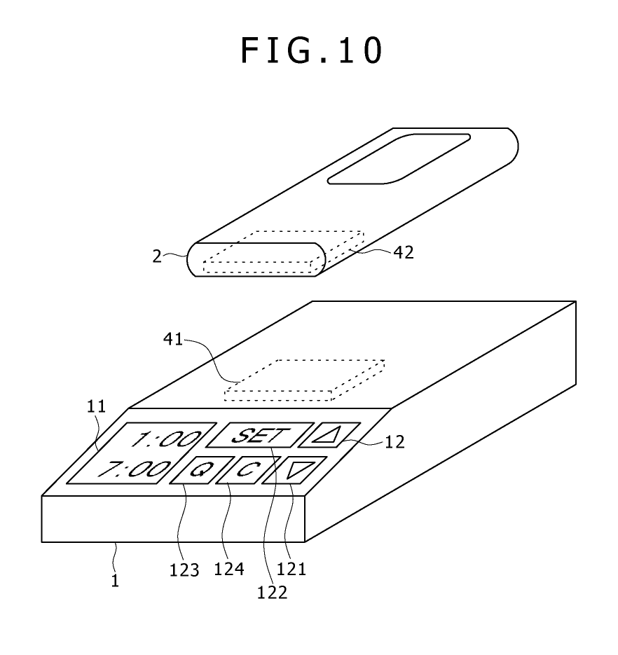

FIG. 10 is a perspective-view diagram showing an external appearance of an electronic apparatus 2 employing a secondary battery 3 and an external appearance of a secondary-battery electrically charging apparatus 1 adopting the noncontact electrical charging method according to the modified version. As shown in this perspective-view diagram, the secondary-battery electrically charging apparatus 1 employs a power transmitting coil 41 connected to the electrical charging circuit 20 whereas the electronic apparatus 2 employs a power receiving coil 42 connected to the secondary battery 3 not shown in the perspective-view diagram. In this typical configuration, the secondary battery 3 is electrically charged by adopting the noncontact electrical charging method in accordance with which power is transferred from the secondary-battery electrically charging apparatus 1 to the portable apparatus 2 by making use of electromagnetic induction between the power transmitting coil 41 and the power receiving coil 42. As shown in the perspective-view diagram which serves as FIG. 10, the secondary battery 3 can be electrically charged by merely placing the electronic apparatus 2 above the upper surface of the secondary-battery electrically charging apparatus 1. It is thus possible to get rid of the complicacy entailed by the necessity to connect the secondary-battery electrically charging apparatus 1 and the electronic apparatus 2 to each other by making use of a connector.

In a typical application according to the first and second embodiments described above, the secondary battery 3 employed in the electronic apparatus 2 is electrically charged by making use of the secondary-battery electrically charging apparatus 1. However, the scope is by no means limited to this typical application. Instead of electrically charging a secondary battery 3 employed in an electronic apparatus 2, it is possible to electrically charge a battery pack having a plurality of aforementioned secondary batteries in another application of the present embodiment.

In a further embodiment, an electrical charging operation is carried out to electrically charge a car battery mounted on an electric or hybrid car driven by a force generated by an electric motor serving as a force generation source. If the present embodiment is applied to an electrical charging operation carried out to electrically charge a car battery mounted on an electric or hybrid car, it is nice to set the electrical-charging end time point Tf at a time point at which the use of the electric or hybrid car is to be started. Thus, it is possible to prevent the car battery from being left uncontrolled in a state of being electrically charged to the full electric-charge storage capacity of the car battery in the an electrical charging operation and, at the same time, since the car battery has been electrically charged to achieve the full electric-charge storage capacity of the car battery at the electrical-charging end time point Tf, the driver can start to use the electric or hybrid car in a state of always having the car battery already electrically charged to the full electric-charge storage capacity of the car battery. In addition, in this further application of the present embodiment, since the operation to electrically charge the car battery is started right after the car battery is connected to the electrically-charging apparatus, it is possible to keep up even with a situation which demands the use of the electric or hybrid car all of a sudden prior to the electrical-charging end time point Tf.

In addition, at the present day, the present embodiment also demonstrates remarkable effects as well even when the present embodiment is applied to a growing number of vehicle utilization systems such as the so-called car sharing system and the so-called rental car system. As already commonly known, the car sharing system allows a plurality of system members registered in advance to make use of the same vehicle whereas the rental car system lets customers rent vehicles. By setting the electrical-charging end time point Tf at a time point reserved by a member or a customer as a time point at which the use of a vehicle is to be started, it is possible to prevent a vehicle battery mounted on a vehicle from being left uncontrolled in a state of being electrically charged to the full electric-charge storage capacity of the vehicle battery in an electrical charging operation. In addition, it is also possible to provide each member or each customer with a vehicle in a state of always having the vehicle battery already electrically charged to the full electric-charge storage capacity of the vehicle battery. It is also possible to keep up even with a situation in which a member or a customer wants to make use of a vehicle such as an electric or hybrid car all of a sudden prior to a time point reserved by the member or the customer.

In addition, the present embodiment can also be applied to the so-called delivery services for delivering articles of food and/or pieces of baggage by making use of vehicles. In this case, by setting the electrical-charging end time point Tf at a time point at which a delivery service is to be started, it is possible to prevent a vehicle battery mounted on a vehicle from being left uncontrolled in a state of being electrically charged to the full electric-charge storage capacity of the vehicle battery and, in addition, it is also possible to make use of a vehicle in a state of having the vehicle battery already electrically charged to achieve the full electric-charge storage capacity of the vehicle battery at the delivery point of time. On top of that, in the case of a delivery service, it is generally possible to obtain the delivery distance to be travelled by a delivery vehicle in advance. Thus, instead of electrically charging the vehicle battery to achieve the full electric-charge storage capacity of the vehicle battery at the electrical-charging end time point Tf, the vehicle battery is electrically charged prior to the electrical-charging end time point Tf with only electric charge demanded by the vehicle to travel the delivery distance.

If the present embodiment is applied to a system such as the car sharing system, the rental car system or the delivery service system, it is nice to construct an electrical charging system in which a server for managing information on members and customers is connected to information terminals and electrically-charging apparatus.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary-battery electrical charging method comprising:
measuring a present time point;
setting an electrical-charging end time point at which an operation to electrically charge a secondary battery is to be terminated;
computing an electrical-charging resumption time point on the basis of said electrical-charging end time point and the length of time it takes to complete said operation to electrically charge said secondary battery at said electrical-charging end time point on an assumption that said operation is started from a state in which the amount of electric charge stored in said secondary battery has reached an electric-charge amount determined in advance; and
carrying out said operation to electrically charge said secondary battery in a first electrical-charging mode in which said operation is stopped after said secondary battery is electrically charged to said electric-charge amount determined in advance and resumed when the present time point reaches said electrical-charging resumption time point.

2. The secondary-battery electrically charging method according to claim 1, further comprising:
detecting the amount of residual electric charge left in said secondary battery at the start of said operation to electrically charge said secondary battery;
computing an electrical-charging demanded time period, which is defined as the length of time it takes to complete said operation to electrically charge said secondary battery at said electrical-charging end time point on the assumption that said operation is commenced at said start of said operation, on the basis of an electric-charge amount detected at said start of said operation as said amount of residual electric charge left in said secondary battery; and
computing a remaining time period between said present time point and said electrical-charging end time point,
whereby, if said remaining time period is determined to be longer than said electrical-charging demanded time period, said electrical-charging control step is executed to carry out said operation to electrically charge said secondary battery in said first electrical-charging mode but, if said remaining time period is determined to be shorter than said electrical-charging demanded time period said electrical-charging control step is executed to carry out said operation in a second electrical-charging mode in which said operation is performed till said electrical-charging end time point is reached without stopping said operation.

3. The secondary-battery electrically charging method according to claim 2,
wherein in said second electrical-charging mode, said operation to electrically charge said secondary battery is carried out in a high-speed electrical-charging mode in which said operation is performed at a speed higher than an ordinary electrical charging speed.

4. The secondary-battery electrically charging method according to claim 1 whereby said operation to electrically charge said secondary battery is carried out by adoption of a noncontact electrical charging method.

5. The secondary-battery electrically charging method according to claim 1, further comprising
inputting a command issued by a user to start said operation to electrically charge said secondary battery whereby, if said command issued by the user to start said operation is received at said input step, said electrical-charging control step is executed to carry out said operation without stopping said operation.

6. The secondary-battery electrically charging method according to claim 1,
wherein said electrical-charging end time point can be set for every day of the week and/or every day of the month.

7. A secondary-battery electrically charging method comprising:
measuring a present time point;
setting an electrical-charging end time point at which an operation to electrically charge a secondary battery is to be terminated;
detecting the amount of residual electric charge left in said secondary battery at the start of said operation to electrically charge said secondary battery; and
carrying out said operation to electrically charge said secondary battery by beginning said operation at said start at which said amount of residual electric charge left in said secondary battery is detected and by adjusting an electrical-charging current so as to terminate said operation at said electrical-charging end time point.

8. A secondary-battery electrically charging apparatus comprising:
time measurement means for measuring a present time point;
electrical-charging end time-point setting means for setting an electrical-charging end time point at which an operation to electrically charge a secondary battery is to be terminated;
electrical-charging resumption-time-point computation means for computing an electrical-charging resumption time point on the basis of said electrical-charging end time point and the length of time it takes to complete said operation to electrically charge said secondary battery at said electrical-charging end time point on the assumption that said operation is started from a state in which the amount of electric charge stored in said secondary battery has reached an electric-charge amount determined in advance; and
electrical-charging control means for carrying out said operation to electrically charge said secondary battery in a first electrical-charging mode in which said operation is stopped after said secondary battery is electrically charged to said electric-charge amount determined in advance and resumed when the present time point reaches said electrical-charging resumption time point.

9. A secondary-battery electrically charging apparatus comprising:
time measurement means for measuring a present time point;
electrical-charging end time-point setting means for setting an electrical-charging end time point at which an operation to electrically charge a secondary battery is to be terminated;
battery residual electric-charge amount detection means for detecting the amount of residual electric charge left in said secondary battery at the start of said operation to electrically charge said secondary battery; and
electrical-charging control means for carrying out said operation to electrically charge said secondary battery by beginning said operation at said start at which said amount of residual electric charge left in said secondary battery is detected and by adjusting an electrical-charging current so as to terminate said operation at said electrical-charging end time point.

10. A secondary-battery electrically charging apparatus comprising:
a time measurement section configured to measure a present time point;
an electrical-charging end time-point setting section configured to set an electrical-charging end time point at which an operation to electrically charge a secondary battery is to be terminated;
an electrical-charging resumption-time-point computation section configured to compute an electrical-charging resumption time point on the basis of said electrical-charging end time point and the length of time it takes to complete said operation to electrically charge said secondary battery at said electrical-charging end time point on the assumption that said operation is started from a state in which the amount of electric charge stored in said secondary battery has reached an electric-charge amount determined in advance; and
an electrical-charging control section configured to carry out said operation to electrically charge said secondary battery in a first electrical-charging mode in which said operation is stopped after said secondary battery is electrically charged to said electric-charge amount determined in advance and resumed when the present time point reaches said electrical-charging resumption time point.

11. A secondary-battery electrically charging apparatus comprising:
a time measurement section configured to measure a present time point;
an electrical-charging end time-point setting section configured to set an electrical-charging end time point at which an operation to electrically charge a secondary battery is to be terminated;
a battery residual electric-charge amount detection section configured to detect the amount of residual electric charge left in said secondary battery at the start of said operation to electrically charge said secondary battery; and
an electrical-charging control section configured to carry out said operation to electrically charge said secondary battery by beginning said operation at said start at which said amount of residual electric charge left in said secondary battery is detected and by adjusting an electrical-charging current so as to terminate said operation at said electrical-charging end time point.
